(19) United States
(12) Patent Application Publication
(10) Pub. No.: US 2009/0208086 A1
(43) Pub. Date: Aug. 20, 2009

(54) Compression and decompression of raw image data

(76) Inventor: Norbert J. Pelc, Los Altos, CA (US)

Correspondence Address: LUMEN PATENT FIRM, 2345 YALE STREET, SECOND FLOOR, PALO ALTO, CA, 94306, US

(21) Appl. No.: 12/378,480

(22) Filed: Feb. 13, 2009

Related U.S. Application Data
(60) Provisional application No. 61/028,998, filed on Feb. 15, 2008.

(51) Int. Cl. G06K 9/36; G06K 9/00

(52) U.S. Cl. 382/131; 382/232; 382/251

(57) ABSTRACT

A lossy compression method for raw image data with noise or error shaping is provided. The compression method reduces the low frequency components of the compression error. The noise shaping improves the quality of the image subsequently formed using the decompressed data. For each sample of raw image data to be compressed, the error from a previously compressed sample is added to form a modified sample. The modified sample is then compressed to form a compressed sample. The compressed sample is decompressed to form a decompressed sample. The error is calculated between the decompressed sample and the modified sample. For computed tomography (CT), the compressed samples are decompressed prior to image reconstruction. The applications include x-ray CT, single photon emission computed tomography (SPECT), positron emission tomography (PET), magnetic resonance imaging (MRI), ultrasound, radiography, fluoroscopy, and angiography.

### CROSS-REFERENCE TO RELATED APPLICATIONS

This application claims priority from U.S. Provisional Patent Application 61/028,998 filed Feb. 15, 2008, which is incorporated herein by reference.

### FIELD OF THE INVENTION

The invention relates generally to image compression. More particularly, the present invention relates to compression and decompression of raw image data that provides noise shaping.

### BACKGROUND

In many imaging systems, large amounts of image data are acquired by a data acquisition subsystem and must be transmitted to another component for further processing or storage, requiring rapid transmission. For some applications, the image data may also be stored or transmitted over a network to a remote location. Examples of imaging systems that generate large amounts of data include tomographic systems, including x-ray computed tomography (CT), single photon emission computed tomography (SPECT), positron emission tomography (PET), and magnetic resonance imaging (MRI). Imaging systems that produce motion images over time, such as ultrasound, fluoroscopy and angiography also generate large amounts of data. Compression of image data increases the data transmission rate for the limited bandwidth of the data transfer interface. Compression also enables more data to be stored in limited data storage resources both within and outside the imaging system.

Image compression can include lossless compression or lossy compression. In lossless compression, the decompressed samples have identical values to the original samples. In lossy compression, the decompressed samples are similar, but not identical, to the original samples; data loss from lossy compression causes noise or error in the decompressed samples. The terms “noise” and “error” are used interchangeably herein to mean noise or error resulting from the use of lossy compression. Lossy compression creates a tradeoff between the bit rate of the compressed samples and the distortion or errors in the decompressed samples.

In certain imaging techniques there are two domains of image-related data: the raw data domain and the spatial domain. The raw data domain, also referred to as the projection domain or sinogram domain, can include 2D projection data, such as obtained for one slice of an object or resulting from a linear array of sensors. Techniques that reconstruct cross-sectional images from multiple sets of raw data measurements are broadly referred to as “tomography.” The projection data can also be 3D in the situation where projection data are obtained for more than one slice of the object or resulting from a two-dimensional array of sensors. Typically, a reconstruction algorithm is used to convert raw projection data in the raw data domain to an image in the spatial domain. Applying a compression algorithm to the projection data in the raw data domain will not produce the same results as applying the same algorithm to the reconstructed image in the spatial domain because of the mathematical relationship between the projection data and the reconstructed image.

Image compression techniques are typically applied to spatial domain image data, for example JPEG compression for photographic images and MPEG compression for moving images. Spatial domain image compression techniques are also applied to reconstruct images in computed tomography for efficient image storage or transmission of the spatial domain image. However, by definition, spatial domain image compression occurs after reconstruction of raw image data, which can cause delays in CT imaging as the reconstruction algorithm must be applied before the image can be compressed.

For the projection, or sinogram, domain, compression and decompression of projection data are applied prior to reconstruction of an image to the spatial domain. Some approaches to compression of raw projection data apply a JPEG image compression method in the projection domain. An example of this approach is described by Bae et al. in U.S. Pat. No. 7,327,866 entitled, “Method and Apparatus for Compressing Computed Tomography Raw Projection Data,” and dated Feb. 5, 2008. However, JPEG or MPEG compressors, such as used in Bae et al., are typically computationally intensive and may not provide the compressed raw data with sufficient speed to meet system requirements. Also, conventional compression approaches do not account for the effects of noise in the raw domain on the spatial domain. Typically, existing raw data compressors create uniformly distributed noise in the reconstructed images on average, thereby regions of interest can be greatly and deleteriously affected due to compression.

The present invention addresses at least the difficult problems of image compression and advances the art with a lossy compression technique for raw image data.

### SUMMARY OF THE INVENTION

The present invention is directed to compression and decompression of image data with noise shaping. An embodiment of the present invention includes a method for compressing image data comprised of a set of data samples, wherein each of the data samples has an original number of bits. The method includes multiple compression cycles, wherein each cycle includes selecting one of the data samples, forming a modified sample based on the selected data and an error, compressing the modified sample to form a compressed sample, decompressing the compressed sampled to form a decompressed sample, and calculating and updating the error based on the decompressed sample, wherein the compressed sample has a smaller number of bits than the original number of bits of each of the data samples. Preferably, the compression cycle is accomplished in real-time.

In a preferred embodiment, the set of data samples is a set of sequential (spatially or temporally) data samples, wherein the selected data sample is adjacent to a previously selected data sample in sequence. In an embodiment, each of the data samples includes a single scalar value, a one-dimensional array, a two-dimensional array, or a three-dimensional array, wherein the error has a dimensionality equal to the dimensionality of the data samples.

In an embodiment, compression of the modified sample includes quantizing the modified sample to a reduced number of quantization levels corresponding to a reduced number of bits, wherein the reduced number of bits is less than the original number of bits. The number of quantization levels can be based on a noise level of at least one of the selected data samples.

In an embodiment, the error calculation includes calculating the difference between the decompressed sample and the modified sample. Additionally, error calculation can also include multiplying the difference by a weighting factor and/or filtering the error. The error calculation can also be based on an accumulated error, wherein the accumulated error is a function of the calculated error of multiple data samples. For initialization, the error can be initialized to zero or another initial value.

In an embodiment, the compressed sample is stored in a data storage device or communicated to an image processor. In a preferred embodiment, the data samples comprise raw image data, wherein the raw data can be reconstructed to form a reconstructed image, and wherein the raw data samples are compressed before reconstruction. In an embodiment, the compressed samples is decompressed and reconstructed for display. Examples of image data of the present invention include computed tomography (CT) data, x-ray CT data, single photon emission computed tomography (SPECT) data, positron emission tomography (PET) data, fluoroscopy image data, ultrasound image data, or magnetic resonance imaging (MRI) data.

Another embodiment of the present invention includes a method for compressing image data of a sequence of frames, wherein each frame includes a plurality of data samples, wherein each data sample in each frame corresponds to another data sample in another frame, and wherein each data sample has an original number of bits. The method includes multiple compression cycles, where each cycle includes selecting one of the frames, selecting a vector of data samples belonging to the selected frame, forming a vector of modified samples based on the vector of data samples and an error vector, compressing the vector of modified samples to form a vector of compressed samples, decompressing the vector of compressed samples to form a vector of decompressed samples, and calculating and updating the error vector based on the vector of decompressed and modified samples.

The present invention is also directed to an apparatus for compressing image data, wherein the image data includes a set of sequential data samples. An embodiment of the apparatus includes a selector for selecting one of the data samples, an adder for adding an error sample to the selected data sample to form a modified sample, a compressor for compressing the modified sample to form a compressed sample, a decompressor for decompressing the compressed sample to form a decompressed sample, and an error calculator for calculating and updating the error sample based on the decompressed sample and the modified sample.

The apparatus executes a plurality of compression cycles, wherein each of said compression cycles comprises the selection of said data sample, forming said modified sample, forming said compressed sample, forming said decompressed sample, calculating said error sample, and updating said error sample, and wherein said selector selects said data samples in sequence. In an embodiment, the apparatus includes a compression subsystem of a CT system, wherein the CT system includes a slip ring interface, and the apparatus includes a data transfer interface for transmitting compressed samples across the slip ring interface.

### BRIEF DESCRIPTION OF THE FIGURES

The present invention together with its objectives and advantages will be understood by reading the following description in conjunction with the drawings, in which:

FIG. 1A shows an example of a basic configuration for CT scan data acquisition.

FIG. 1B shows an example of data collected from a row of sensors of a CT data acquisition system.

FIG. 2 shows a block diagram of a data compression system according to the present invention.

FIGS. 3A-C show examples of data samples to be compressed and sample selection process according to the present invention.

FIGS. 4A-C show examples of error calculators according to embodiments of the present invention.

FIG. 5 shows an example plot of noise shaping from the compression of CT data according to the present invention.

FIG. 6 shows a block diagram of a compressor that adjusts to the noise of the input data samples according to the present invention.

FIG. 7 shows a block diagram of processing the compressed samples for image formation and display according to the present invention.

### DETAILED DESCRIPTION OF THE INVENTION

The present invention is directed to compression and noise or error shaping of image data, including spatial domain image data and raw projection data. In particular, the present invention is directed to lossy compression methods that preserve the accuracy of low frequency data in a spatial or temporal dimension. For spatial domain image data, the compression includes noise shaping that preserves the quality of the image data and of computations derived from the image. For raw projection data, compression allows more efficient data transfer from the data acquisition subsystem to a storage subsystem and/or an image reconstruction processor. Later decompression of the compressed projection data is applied prior to image reconstruction. The benefits of compression include reducing latency between data acquisition and image display, increasing the volume of data transferred over a communication channel having limited bandwidth, and providing compressed projection data for storage and transmission over a network for later access and image reconstruction. Since compression allows the system resources to accommodate more projection data per unit time, the image quality can be improved and/or a larger region of the object can be scanned and/or the scanning speed can be increased. The availability of computing resources to implement compression operations is also a constraint in imaging systems, such as computed tomography (CT) systems.

It is important to note that the present invention is also directed to error shaping during the compression of projection data, which, as described below, reduces error in the central portion of the reconstructed image. The present invention is independent of the number of views used by the image reconstruction processor to compute a reconstructed image. The present invention is also applicable to compression and decompression of raw data for motion images. For this application, the compression provides noise shaping within a frame or from frame to frame of the moving image. The noise shaping improves the quality of the resulting motion images.

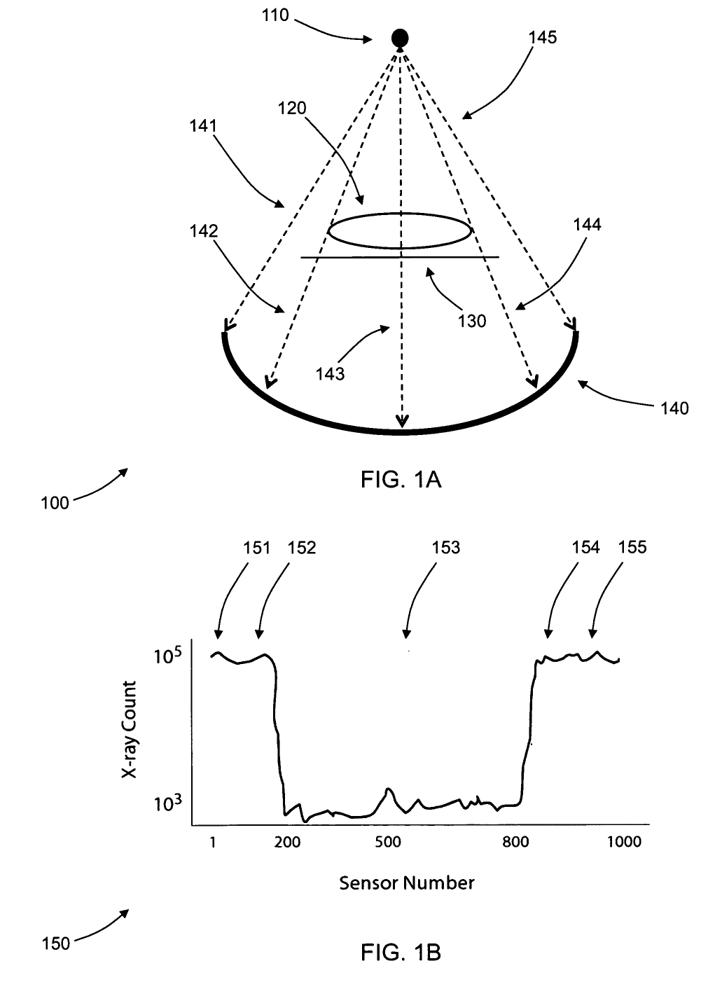

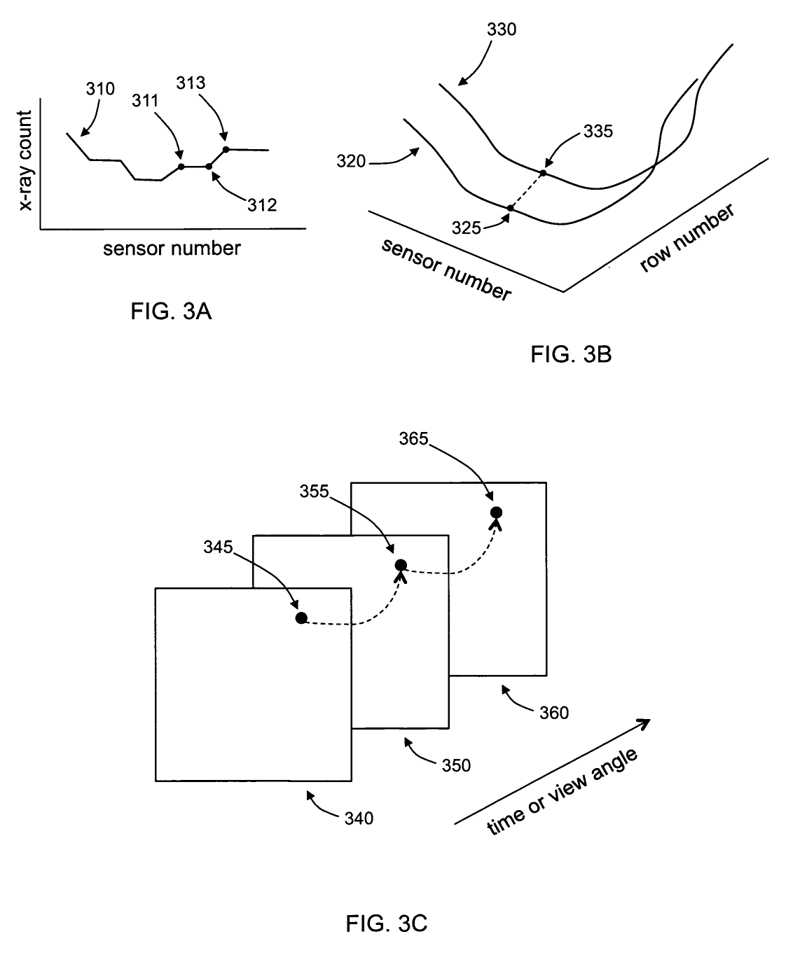

The compression and noise shaping of raw CT projection data mitigates the effects of compression error in the reconstructed image. Lossy compression of raw CT projection data generates errors in the reconstructed image having complicated characteristics. The distribution of the errors in the projection, or sinogram, data creates different effects in different portions of the reconstructed image. For example, for 2D imaging the sinogram domain has axes for two independent variables. One axis corresponds to the position of a data sample within one projection and is referred to as the s-axis. This axis corresponds to the “sensor number” axis in FIGS. 1B and 3. The other axis corresponds to the view angle of the projection with respect to the object. Because most CT scanners sample the angle dimension sequentially in time as the gantry rotates, this dimension is referred to as the temporal direction. This axis corresponds to the “time or view angle” axis in FIG. 3. The temporal frequency of the noise, or compression error, in the projection data affects the location of artifacts in the reconstructed image. Temporal frequency refers to the frequency from view to view, or with respect to the view angle. For example, for a CT scanner using a fan-beam x-ray source, low temporal frequency noise in the most central detector elements within the array will affect the central portion of the reconstructed image. For image reconstruction, the summing operations for back projection will cause an accumulation of errors in the central portion of the reconstructed image. This is because low temporal frequency errors in the samples of the projection data that correspond to the more central detectors add coherently in the central part of the image when they are back projected. On the other hand, the high temporal frequency errors in the central portion will tend to cancel when they are back projected into the central image region. These high temporal frequency errors, even if they occur in the central detectors, can only affect the periphery of the reconstructed image. Thus, lossy compression that does not produce low temporal frequency noise can preserve image quality in the central portion of the reconstructed image.

Lossy compression that does not produce substantial low temporal frequency noise can also preserve quality when applied to a time series of images. For a time series of images, the raw data have one or more spatial dimensions and one or more temporal directions. Multiple temporal dimensions occur, for example, if one has images as a function of time in the cardiac cycle and also as a function of time in the respiration cycle. In such a time series of images, one may later want to calculate the mean of image intensities over time or other metrics of the temporal dynamics. Thus, when using lossy compression on such data it would be advantageous to use a compression method in which compression errors in nearby time samples tend to cancel, i.e., to preserve the accuracy of the low temporal frequencies in the dynamic image data.

A variety of compression methods are presented to preserve the accuracy of low frequency information in any spatial or temporal dimension. One method is to filter the input data with a filter A that amplifies low frequencies and suppresses high frequencies. The filtered data are compressed and then transmitted and/or stored as desired. When the data are needed, they are decompressed and then filtered with a filter B that is the inverse of filter A. The pre- or post-compression filtering can be performed using convolutions, using recursive filters, or with Fourier analysis, or any other technique. A preferred method according to the present invention is to use error feedback, as described in detail below, to preserve the accuracy of low frequency information. This method is preferred because it can be implemented to work in real-time.

In computerized tomography scanners, an x-ray source and detector array are rotated about the object being imaged by a rotating gantry. The projection data acquired by the detector array are transmitted via a communication channel between the rotating unit and stationary unit of the gantry system to a storage system and later to a processor for image reconstruction. The bandwidth limitation of the communication channel determines the speed of transmission of the projection data to the processor for use in image reconstruction. An embodiment of the present invention is directed to compressing projection data prior to transmission so that more data can be transferred more rapidly across the limited bandwidth channel. In applications where the projection data are stored, compression of the projection data allows more data to be stored in a given memory capacity or reduces the memory capacity requirements. Preferably, decompression of the compressed projection data occurs prior to reconstruction of an image. Compressing the projection data prior to data transfer followed by decompression before image reconstruction processing reduces the burden on system resources for data transfer and storage.

In the present discussion, “real-time” compression refers to any situation wherein the time between the acquisition of a sample and the completion of the compression and disposition of the sample is small enough to not be a significant barrier, for example when the time required for compressing one sample in a series of samples is much less than the time required for acquiring the entire series of samples. In an example, real-time refers to an implementation in which the sample acquisitions and compressions are overlapped, i.e. the entire series of data samples need not be acquired before compression begins. Real-time compression can also include short time lags and/or the use of memory buffers.

The term “real-time” can be used to describe rates for processing, transfer, and/or storage of the digital signal. The sample rate is the rate at which an analog-to-digital converter (ADC) forms samples of a digital signal during conversion of an analog signal. The bit rate of an uncompressed sampled, or digital, signal is the number of bits per sample multiplied by the sample rate. The compression ratio is the ratio of the bit rate of the original signal samples to the bit rate of the compressed samples. “Real-time” can also mean a processing rate that is comparable to the sample rate of the input signal.

A preferred embodiment of the present invention is directed to compression and decompression of CT raw data, however, the present invention can be applied to other types of data. FIG. 1A is an illustration representing the basic configuration for CT scan data acquisition in a CT imaging system. An object or patient 120 is positioned on a platform 130 that can be moved back and forth within a rotating gantry (not shown) of a CT imaging system. The gantry includes an x-ray source 110 and a data acquisition subsystem (DAS) 140. The DAS 140 includes a matrix of one or more rows of x-ray sensors and ADCs. The ADCs digitize signals from the x-ray sensors to produce samples whose amplitudes represent the transmitted x-ray intensity (x-ray counts). CT systems can include a matrix of approximately 1024 x-ray sensors per slice, or row, and approximately 320 rows per view. The x-ray source 110 generates a beam having a particular geometry, depending on the system design. The example shown in FIG. 1A has fan-beam geometry. The degree of attenuation of the x-ray depends on its path. In FIG. 1A, the rays 141 and 145 are unattenuated because they travel through the air. The ray 143 is attenuated because it is partially absorbed when traversing the object 120. The rays 142 and 144 traverse boundaries of the object 120, so they will be less attenuated than ray 143. The array of x-ray sensors measures the received x-rays to form signals for the ADCs.

The x-ray sensors of CT scanners require a dynamic range of many orders of magnitude to capture the range of attenuated and unattenuated x-ray signals from the x-ray source 110. The x-ray sensors of current CT scanners use ADCs that sample the x-ray sensor output using 16 to 24 bits per sample. For 16 bits per sample, the maximum (unattenuated) x-ray count is 2¹⁶, or 65,536. For 24 bits per sample the maximum x-ray count is 2²⁴, or 16,777,216.

For each view angle, the DAS 140 produces a set of projection data. The set of projection data includes an array of data samples, where a line of samples in the array, or scan line, corresponds to the measurement of x-rays made by one row of the detector array and generally correspond to x-rays passing through a slice of the object 120. As the gantry rotates around the patient, multiple sets of projection data are captured and transferred across the slip ring to an external computer or processor (not shown). The processor applies an image reconstruction algorithm to the sets of projection data to form an image. The image reconstruction algorithm can produce two-dimensional cross-sectional images or three-dimensional images of the scanned object, depending on the scan protocol. The reconstructed image is then displayed for analysis by a user. The particular geometry of the x-ray source beam, the detector geometry, DAS 140 configuration or scan protocol do not limit applications of the present invention.

FIG. 1B illustrates an example of a signal formed by projection data output from a row of sensors, such as the sensors of DAS 140. The regions 151 and 155 correspond to the unattenuated rays 141 and 145 and have the maximum x-ray counts. The regions indicated by 152 and 154 are transitional regions that represent the rays detected at the boundaries 142 and 144. The region indicated by 153 corresponds to attenuated ray 143 that has traversed the object 120 and thus has a substantially lower x-ray count.

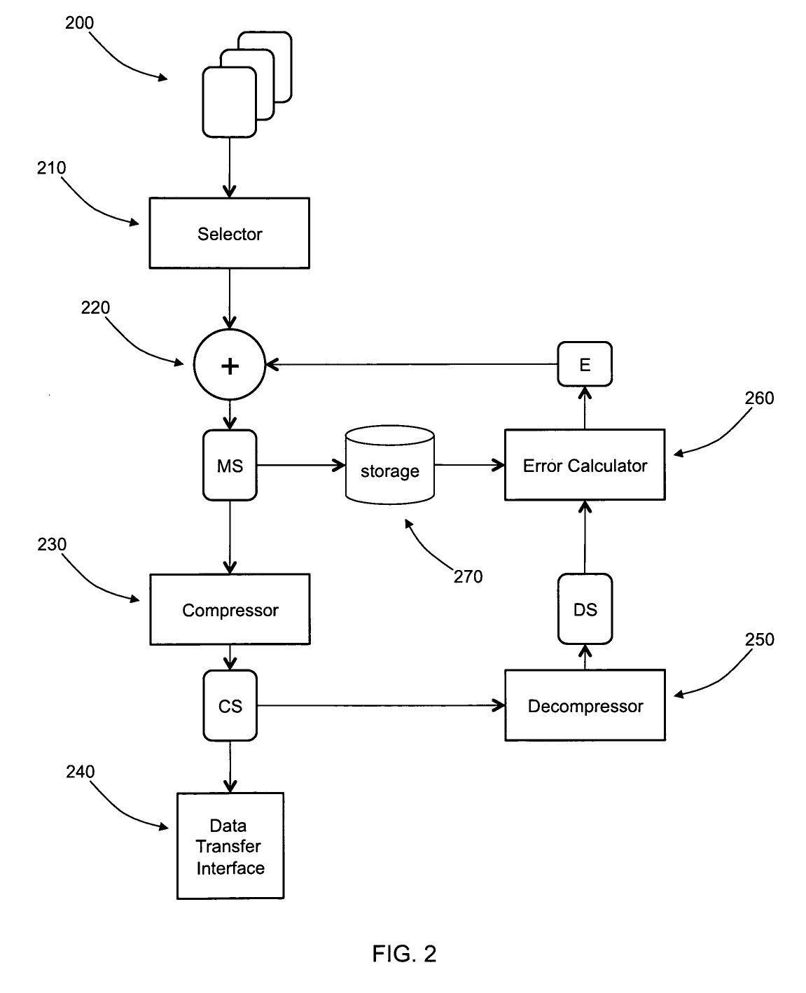

FIG. 2 is a block diagram of a compression system in accordance with a preferred embodiment. An input buffer of the compression system contains raw image data organized as one or more sets of data samples 200. The raw image data is provided by a data acquisition system of an imaging system, for example projection data from DAS 140 of a CT scanner. The system of FIG. 2 compresses data in each array while preserving the accuracy of the low (spatial or temporal) frequency content of the data within each array. At the beginning of a compression cycle, the selector 210 selects one or more of the data samples 200 to be compressed. The selector 210 may select a sample from the same array or a different array than the previously selected sample. The adder 220 adds the compression error E from the previously compressed sample to the current selected sample to form a modified sample MS. For initialization, the initial error for adder 220 is set to zero or another initial value. Alternatively, the error can be initialized for an initial array in a sequence. The storage element 270 stores the modified sample MS for the error calculation that will follow. The compressor 230 compresses the modified sample MS to form a compressed sample CS. The decompressor 250 decompresses the compressed sample CS to form a decompressed sample DS. The error calculator 260 calculates the error E between the modified sample MS and the decompressed sample DS. This completes a compression cycle. The error E is ready to be added to the next selected sample. This process is repeated for a subset or all of the data samples 200 in the array or set of data samples to form an array or set of compressed samples.

It is noted that each of the input data samples 200 has an original number of bits. In a preferred embodiment, each of the compressed samples CS has a number of bits less than or equal to the original number of bits of the data samples 200. The array of compressed samples can be formatted and packed for transmission across a data transfer interface 240. Note, however, that each compressed sample can be transmitted as soon as it is computed. That is, there is no need to wait until all the elements of the array have been compressed to begin data transmission.

As just described, each compression cycle of the system of FIG. 2 processed one sample. The system can be configured to process a vector of samples in each compression cycle. With this approach, selector 210 selects a vector of data samples to be compressed. For a CT system, for example, the vector of samples is a vector of projection data at a view angle. For a time series of images, the vector of samples is a vector of raw image data values within a time frame. Adder 220 adds a vector of compression errors from the previous compression cycle to the current vector of samples to form a vector of modified samples. These are stored in storage element 270. Each element of the vector of modified samples is compressed by compressor 230 to form a vector of compressed samples CS. These are decompressed and error calculator 260 calculates a vector of error samples to be used in the next cycle. This continues until the array of vectors or a sequence of frames or view angles has been processed. As with the processing described previously, the feedback of error from one cycle to the next prevents low frequency compression errors from building up.

FIGS. 3A-C illustrate examples of selection processes that can be applied by the selector 210. Each of the data samples 200 can include a single scalar value, a one-dimensional array, a two-dimensional array, or a three dimensional-array. The error E used to modify the selected data samples 200 has a dimensionality equal to the dimensionality of the data samples 200.

The example in FIG. 3A shows a linear array of digitized sensor data 310 from a set of sensors corresponding to a row of an input array. In FIG. 3A, the selector 210 selects a consecutive sample along the linear array for each compression cycle. Samples 311, 312 and 313 would be selected consecutively in three compression cycles. In other words, the set of data samples is in sequence and the selector 310 selects a data sample that is adjacent to a previously selected data sample in the sequence. The sequence can be in space or in time.

FIG. 3B shows an example plot of data samples of two linear arrays 320 and 330 of digitized sensor data corresponding to two rows of an input array. In FIG. 3B, the selector 210 selects samples 325 and 335 in corresponding positions in the linear arrays 320 and 330 in two consecutive compression cycles. Alternatively, the selector 210 can select a vector of samples (e.g. multiple points along each of the two linear arrays 320 and 330) at each compression cycle so that the compression operations of FIG. 2 are applied to the vector of samples in parallel.

FIG. 3C illustrates successive frames of input data samples 340, 350, and 360. For a CT system, the frames 340, 350, and 360 can correspond to the projection data acquired at three sequential view angles. For an imaging modality that produces motion images, the frames 340, 350 and 360 can correspond to three frames of image data acquired over time. In FIG. 3C, the selector 210 selects data samples in corresponding positions 345, 355, and 365 in the frames 340, 350, and 360 in consecutive compression cycles. Alternatively, the selector 210 can select a vector of samples at each compression cycle so that the operations of FIG. 2 can be performed in parallel. These or other selection processes appropriate for the implementation and imaging modality can be determined by the user.

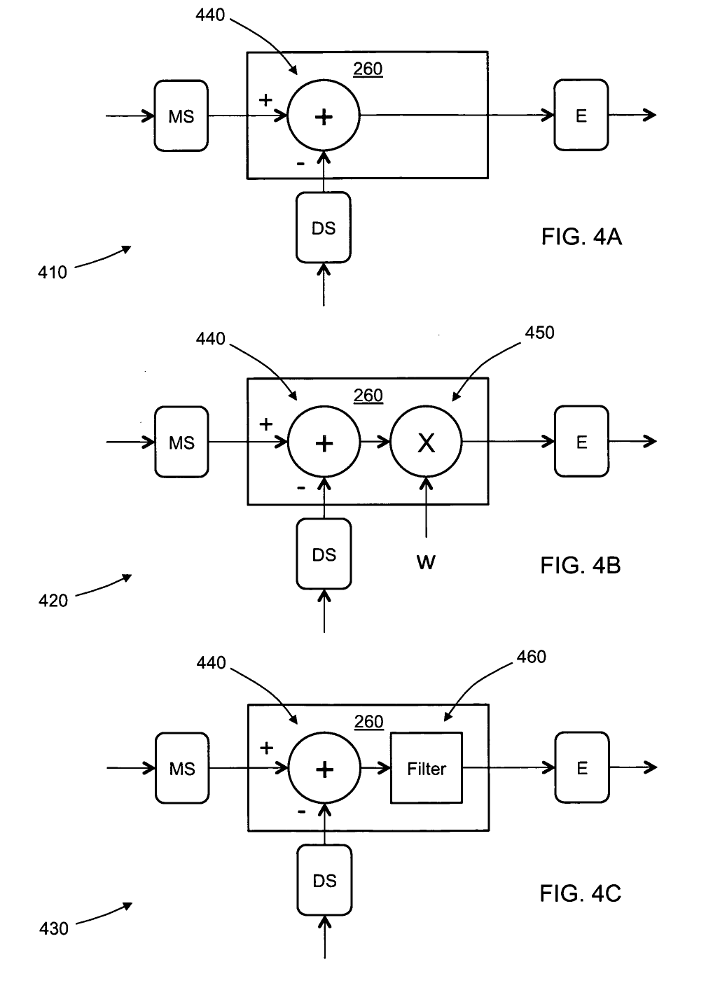

FIGS. 4A-C show several alternative configurations for the error calculator 260. In the embodiment 410, the error calculator 260 includes a subtractor 440 that subtracts the decompressed sample DS from the corresponding modified sample MS to form a difference value. The difference value provides the error E that is added to the next sample by the adder 220. In the configuration 420, a multiplier 450 multiplies the difference value determined by subtractor 440 by a factor w to form a weighted error E for input to the adder 220. In configuration 430, the error calculator includes a filter 460 that produces a filtered error E for input to the adder 220. The filter 460 can include any type of filter, such as a smoothing filter that calculates a convolution of the difference values with a kernel. In an embodiment, the error E is calculated and added to the selected sample at every compression cycle. Alternatively, the error E can be accumulated for a number of compression cycles and added to the selected sample at a subsequent compression cycle.

The calculation of error E and its addition to the next sample by adder 220 shapes the noise caused by lossy compression. Referring to FIG. 3A, the direction of the shaping is along the linear array. For FIG. 3B, the direction of noise shaping is from line to line. For the example shown in FIG. 3C, the direction of noise shaping is in the temporal direction, from frame to frame or along view angle for CT data. In particular for CT projection data, the noise shaping reduces error having low temporal frequency.

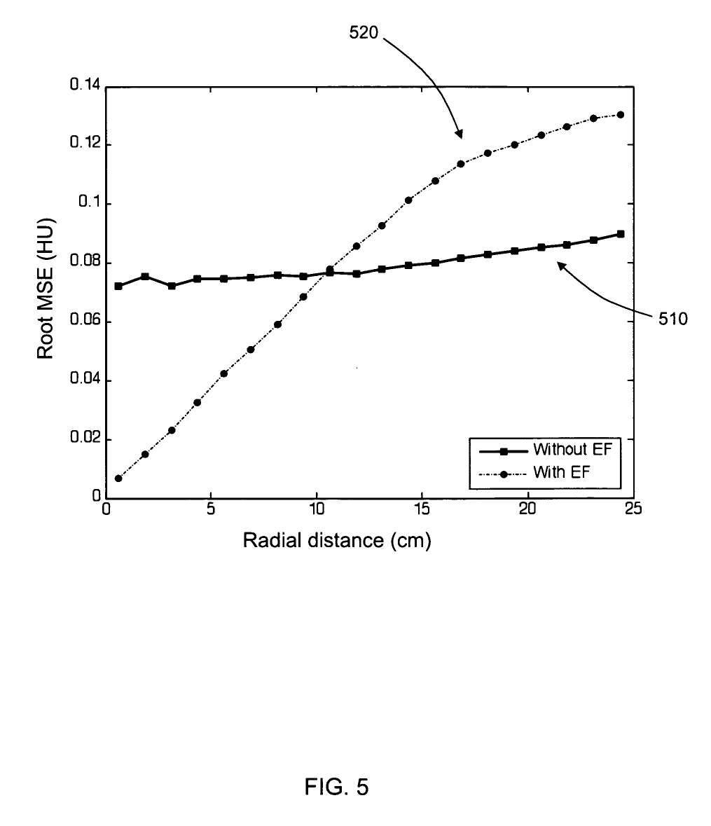

For raw image data, reducing the low temporal frequency error reduces the effect of compression errors in the central portion of the reconstructed image. FIG. 5 shows a plot of errors versus radial distance for the compression of simulated CT data of a thorax. Plot 510 shows compression error without the use of error feedback as described above. Plot 520 shows compression error from compression with error feedback. Whereas plot 510 shows an approximately uniform compression error that does not depend on the radial distance from the center of the image, plot 520 shows that with error feedback, the compression error can depend strongly on the radial distance. Though plot 520 shows increased errors toward the periphery of a field of view over plot 510, it has substantially reduced errors in the center of the field of view. This trade-off may be acceptable for many applications, such as pediatrics or cardiac imaging, where the region of interest is commonly located at the center of the image.

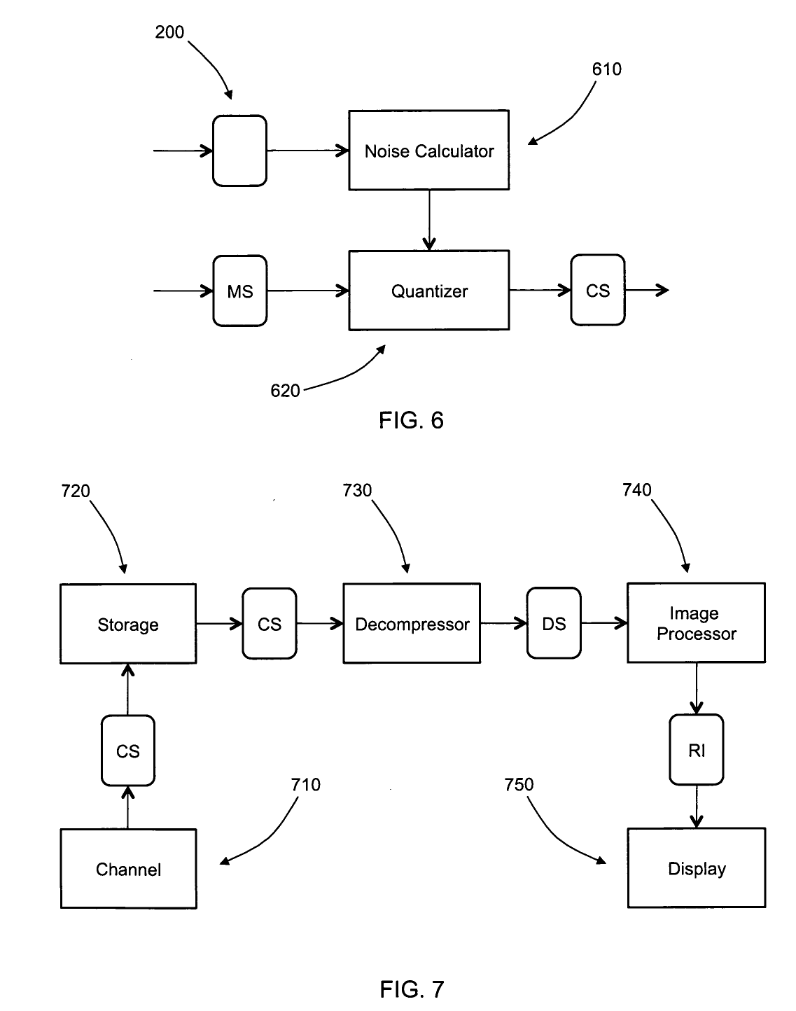

In a preferred embodiment, the compressor 230 performs operations to map the modified sample MS having an original number of bits to a compressed sample CS having a reduced number of bits. A simple embodiment of the compressor 230 includes a quantizer that applies fewer quantization levels to the modified sample MS to produce a compressed sample CS that is represented with a reduced number of bits. The compressor 230 can apply the same quantization to all the modified samples. In an alternative embodiment, an adaptive quantizer can adjust quantization depending on the noise level of the sample. FIG. 6 shows a block diagram for the compressor 230 that adjusts to the noise of samples in the input data samples 200. A noise calculator 610 calculates the noise level of one or more data samples in the array 200. The quantizer 620 quantizes the modified sample MS so that the quantization noise level will be proportional to the noise level. The quantizer 620 determines the quantized value, .δ from an input sample d as follows,

δ=RND(kd/σ_{d}) (1)

where σ_{d} is the noise level of the input sample, k is a constant and RND(x) is a rounding operator that rounds x to the nearest integer. The quantizer 620 provides the quantized value ,δ. of the compressed sample CS.

For x-ray data, including CT raw data, the noise level of a sample of a detector measurement can be calculated using a well-known data model. In accordance with this data model, the noise level depends on the amplitude of the detector signal. The relationship between the noise and the amplitude of electronic x-ray measurements is described by the present inventor Norbert J. Pelc in the article entitled “Statistical aspects of digital x-ray imaging,” in Electronic Imaging in Medicine, G. D. Fullerton et al., eds., AAPM Monograph 11, American Institute of Physics, New York, 1984. As described in the article, the noise in a sensor signal that has been linearly digitized is given by the following equation,

σ_{d}²=C²QN+QNσ_{c}²+σₑₗ²+b²/12 (2)

where ,σ_{d}². is the variance in the digitized detector signal, N is the number of x-ray photons, Q is the quantum detection efficiency, C²is the square of the expected signal per detected photon, σ_{c}². is the variance in the signal per photon, ,σₑₗ². is the variance from electronic noise, and b is the bit size in the digitization of the detector signal d. All the terms in Equation 2 must be in the same units (e.g., ADC counts squared). In an embodiment, equation (2) is used to predict the noise level σ_{d}.

The detector signal d above is modeled as follows,

d=,C.QN (3)

For example, suppose that d is a 20 bit number so that the maximum value of signal d is 2²⁰. Also, suppose the following: C=0.03 ADC counts per photon, Q=0.9, σ_{c}².=4×10⁻⁵⁻⁵, and σₑₗ².=4. For this example, the maximum value of d=2²⁰ corresponds to 38.8 million photons. The noise level ,σ_{d}. of signal d is about 181. Setting k=1, d=2²⁰ and σ_{d}.,=181, gives a quantized value ,d. of 5,782. This value of ,d. can be represented by a 13 bit number, since 2¹³=8,192. A value of k up to 1.4 (1.4=8192/5782) would produce a quantized value ,d. that uses 13 bits. Since the maximum value of d can be represented using 13 bits, any value of d can be represented by a 13 bit number.

The decompressor 250 uses the compressed sample CS to form an estimate of the corresponding modified sample MS. When the compressor includes a quantizer 620, multiple values within a range are mapped to a single quantized value for that range. For decompression, the quantized value is mapped to the midpoint of the original range. In an embodiment, the mapping is implemented using a lookup table. For example, for the original sample having 20 bits and the compressed sample having 13 bits, the decompressor 250 maps the 13 bit sample to the 20 bit sample that corresponds to the midpoint of the original range. The lookup table includes 2¹³ entries of quantized values and the associated 20 bit decompressed value.

The type of data transfer interface 240 depends on the application. For a CT scanner, the data transfer interface 240 includes a slip ring interface. The data transfer interface 240 can transfer the compressed samples CS to a storage device, a reconstruction engine, or an image processor, depending on the system configuration. The data transfer interface 240 can also include a network or other communication device to transfer the compressed samples CS to a remote location.

FIG. 7 shows a block diagram of processing the compressed samples CS for image formation and display. Storage device 720 stores the compressed samples CS received from communication channel 710. The decompressor 730 decompresses the compressed samples CS to form decompressed samples DS. The image processor 740 performs the operations appropriate for the application on the decompressed samples DS to form an image for display 750. For computed tomography applications, the image processor applies image reconstruction algorithms to produce a reconstructed image RI for display 750. It is noted that the display 750 can include a monitor, a printer, or any device capable of visually displaying the processed or reconstructed image RI.

The compressor of the present invention can be implemented as a compression subsystem in an imaging system for many applications. The applications include x-ray CT, single photon emission computed tomography (SPECT), positron emission tomography (PET), magnetic resonance imaging (MRI), ultrasound, radiography, fluoroscopy, and angiography. The present invention can also be used in nonmedical applications, including non-destructive testing, security, and others. For computed tomography applications, the compression subsystem can be incorporated in the DAS 140. In an application specific integrated circuit (ASIC) that includes an ADC, the compression subsystem can be integrated into the ASIC to compress samples output from the ADC. In an alternative implementation, the compression subsystem is embodied in a separate device that is coupled to the output of an ADC chip. The device can be implemented as an ASIC, a field programmable gate array (FPGA), or a programmable processor, such as a digital signal processor (DSP), microprocessor or microcontroller. Depending on the system architecture, the decompression subsystem may be incorporated into the same device as or a different device from the image reconstruction processor. The decompression subsystem could be implemented in an ASIC, FPGA or programmable processor.

As one of ordinary skill in the art will appreciate, various changes, substitutions, and alterations could be made or otherwise implemented without departing from the principles of the present invention, e.g. other types of data not listed herein can be compressed. Accordingly, the scope of the invention should be determined by the following claims and their legal equivalents.

What is claimed is:

1. A method for compressing image data, wherein said image data comprises a set of data samples, wherein each of said data samples has an original number of bits, said method comprising:
(a) selecting one of said data samples;
(b) forming a modified sample based on said selected data sample and an error;
(c) compressing said modified sample to form a compressed sample, wherein said compressed sample has a smaller number of bits than the original number of bits of said selected data sample;
(d) decompressing said compressed sample to form a decompressed sample;
(e) calculating and updating said error, wherein said calculating is based on said decompressed sample; and
(f) repeating steps (a) through (e) for said set of data samples to form a set of compressed samples.

2. The method as set forth in claim 1, wherein said set of data samples is a set of sequential data samples, and wherein said selected data sample is adjacent to a previously selected data sample in said sequence.

3. The method as set forth in claim 2, wherein said sequential data samples are in sequence in space or in time.

4. The method as set forth in claim 1, wherein each of said data samples comprise a single scalar value, a one-dimensional array, a two-dimensional array, or a three-dimensional array, wherein said error comprises an error vector, and wherein the dimensionality of said error vector is less than or equal to the dimensionality of said data samples.

5. The method as set forth in claim 1, wherein said compression of said modified sample comprises quantizing said modified sample to a reduced number of quantization levels corresponding to a reduced number of bits, and wherein said reduced number of bits is less than said original number of bits.

6. The method as set forth in claim 5, further comprising determining a noise level of at least one of said selected data samples, wherein said number of quantization levels is based on said noise level.

7. The method as set forth in claim 1, further comprising initializing said error.

8. The method as set forth in claim 1, wherein said error calculation comprises calculating the difference between said decompressed sample and said modified sample.

9. The method as set forth in claim 1, wherein said error calculation comprises multiplying said error by a weighting factor.

10. The method as set forth in claim 1, wherein said error calculation comprises filtering said error.

11. The method as set forth in claim 1, further comprising calculating an accumulated error, wherein said accumulated error is a function of said calculated error of multiple of said data samples, and wherein said modified sample is based on said accumulated error.

12. The method as set forth in claim 1, further comprising storing said compressed sample in a data storage device.

13. The method as set forth in claim 1, wherein said data samples comprise raw data samples, wherein said raw data samples can be reconstructed, and wherein said raw data samples are compressed before said reconstruction.

14. The method as set forth in claim 13, further comprising reconstructing one or more of said decompressed data samples to form one or more reconstructed images.

15. The method as set forth in claim 1, wherein said image data comprises computed tomography (CT) data, and wherein each of said data samples represents a CT view angle.

16. The method as set forth in claim 1, wherein said image data is selected from the group consisting of tomography data, x-ray computed tomography data, single photon emission computed tomography (SPECT) data, positron emission tomography (PET) data, fluoroscopy image data, ultrasound image data, and magnetic resonance imaging (MRI) data.

17. The method as set forth in claim 1, wherein said compression is in real-time.

18. A method for compressing image data of a sequence of frames, wherein each of said frames comprises a plurality of data samples, wherein each of said data samples in each of said frames corresponds to another of said data samples in another of said frames, wherein each of said data samples has an original number of bits, said method comprising:
(a) selecting one of said frames;
(b) selecting a vector of said data samples belonging to said selected frame;
(c) forming a vector of modified samples based on said vector of data samples and an error vector;
(d) compressing said vector of modified samples to form a vector of compressed samples, wherein each of said compressed samples has a smaller number of bits than the original number of bits;
(e) decompressing said vector of compressed samples to form a vector of decompressed samples;
(f) calculating and updating said error vector, wherein said calculating is based on said vector of decompressed samples and said vector of modified samples; and
(g) repeating steps (a) through (f) for said sequence of frames, wherein said selected frame is adjacent to said previously selected frame, and wherein said selected vector of data samples corresponds to said previously selected vector of data samples.

19. An apparatus for compressing image data, wherein said image data comprises a set of sequential data samples, wherein each of said data samples has an original number of bits, said apparatus comprising:
(a) a selector for selecting one of said data samples;
(b) an adder for adding an error sample to said selected data sample to forming a modified sample;
(c) a compressor for compressing said modified sample to form a compressed sample, wherein said compressed sample has a smaller number of bits than the original number of bits of said selected data sample;
(d) a decompressor for decompressing said compressed sample to form a decompressed sample;
(e) an error calculator for calculating and updating said error sample, wherein said error sample is based on said decompressed sample and said modified sample,
wherein said apparatus executes a plurality of compression cycles, wherein each of said compression cycles comprises the selection of said data sample, forming said modified sample, forming said compressed sample, forming said decompressed sample, calculating said error sample, and updating said error sample, and wherein said selector selects said data samples in sequence.

20. The apparatus as set forth in claim 20, wherein said apparatus comprises a compression subsystem of a computerized tomography (CT) system, wherein said CT system comprises a slip ring interface, said apparatus further comprising a data transfer interface for transmitting said compressed samples across said slip ring interface.
